(19) United States
(12) Patent Application Publication
(10) Pub. No.: US 2009/0135978 A1
(43) Pub. Date: May 28, 2009

(54) Apparatus and method for estimating and compensating sampling frequency offset

(76) Inventors: Chi-Tung Chang, Taipei (TW); Tzu-Wen Sung, Taipei (TW); Chuen-Heng Wang, Taipei (TW); Yu-Ling Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,819

(22) Filed: Mar. 11, 2008

(30) Foreign Application Priority Data
Nov. 28, 2007 (TW) 96145109

(51) Int. Cl. H04L 7/00; H04L 25/00

(52) U.S. Cl. 375/371

(57) ABSTRACT

An apparatus and method for estimating and compensating sampling frequency offset are disclosed. Particularly, a linear mathematical scheme is employed to calculate the related phase difference for saving use of multipliers and storage circuit used for sampling frequency offset estimation and compensation in the conventional art. The preferred embodiment of the invention has a first step to receive signals by the offset estimating circuit. Next, the phase value for each signal is calculated, and the pilot signal therein is retrieved. Next, a phase difference is obtained by subtraction operation between the received symbols and the delayed pilot symbols. And a circuit for storing the phase differences is incorporated. Next, a phase difference between the adjacent symbols is obtained by accumulating the phases and processing the least-error-sum-of-squares operation. Therefore, an estimation value of the sampling frequency offset of a communication system is obtained, and further to compensate the offset.

### BACKGROUND OF THE INVENTION

1. Field of the Invention

The present invention relates to an apparatus and method for estimating and compensating sampling frequency offset, more particularly to employ a signal-phase storing circuit and a sampling-frequency-offset estimating and compensating circuit to calculate the phase differences instead of the conventional storing circuit and multiplier.

2. Description of Related Art

Orthogonal frequency division multiplexing (OFDM) technology is a modulation architecture used for a communication system, such as IEEE802.11a, which is very sensitive to frequency offset. Two major reasons cause the frequency offset. One of the reasons is that a frequency oscillator in a transmitter has different frequency from the oscillator in a receiver, and the other reason is that the movement of the wireless terminal device causes Doppler effect. Since the frequency offset causes the OFDM system to produce intercarrier interference (ICI), the performance of the system largely decreases. So that, to solve the frequency offset is very important to the transmission system using OFDM technology.

The mentioned frequency oscillators of the transmitter and the receiver are used for digital-to-analog conversion (DAC) and analog-to-digital conversion (ADC). Then the sampling frequency during transmission is not precise, and the sampling interval between the transmitter and the receiver makes an error. So that the timing for each symbol gradually gets offset and causes the sub-carrier to rotate, and further the phase for each symbol also gets offset. Likewise, since the sampling time is not correct, the orthogonality between the sub-carriers is reduced. Therefore, the mentioned. Intercarrier Interference forms and signal-noise-ratio (SNR) loses.

So that, in order to compensate the offset as generating signals, the mentioned OFDM technology utilizes some estimation circuitries for sampling frequency offset. The pilot signals retrieved from the entering symbols are employed by the conventional sampling frequency offset estimation circuit. When the number of entering symbols reaches a pre-set number, the pilot signals of preceding half symbols are retrieved and being accumulated with the pilot signals retrieved from the last half symbols. Next, the accumulating value is processed by a conjugate multiplication. Further, the phase values are obtained for calculating the phase difference between the adjacent symbols. After that, a least-error-sum-of-squares principle is used for obtaining the sampling frequency offset estimation value.

Since the sampling frequency offset estimation circuit is easily influenced by the channel under any condition as processing, the estimating process should be operated after the equalizer. After that, the estimation quality will be restricted by the equalizer and the estimation circuit has very low convenience and integration.

In one OFDM system, the input signal influenced by the sampling frequency offset is described as equation (1):

$${S}_{l , k} = {H}_{k} \times {P}_{l , k} \times {e}^{- j 2 π l ( \frac{{kN}_{OFDM} ɛ}{N} )} + {N}_{noise , l} \qquad ( 1 )$$

wherein, l is the index of the symbol of OFDM, k shows the subcarrier position of OFDM, Hₖ present the channel effect, P_{l,k} is the original signal without any influence, and ε presents the sampling frequency offset value. Since there are specific carriers transmitting the pilot signals, and the N_{noise,l} in equation (1) includes the noise and ICI effect caused by the sampling frequency offset. In order to eliminate the effect, the carriers with the pilot signals are divided by P_{l,k}, and the accumulated two parts of symbols are processed as the equations (2) and (3):

$$\begin{matrix}\frac{{S}_{l , k}}{{P}_{l , k}} + \frac{{S}_{l + 1 , k}}{{P}_{l + 1 , k}} + … + \frac{{S}_{l + {l}_{sum} - 1 , k}}{{P}_{l + {l}_{sum} - 1 , k}} + ( {N}_{noise , l} + {N}_{noise , l + 1} + … + {N}_{noise , l + {l}_{sum} - 1} ) = {H}_{k} \times {e}^{- j 2 π l ( \frac{{kN}_{OFDM} ɛ}{N} )} ( 1 + {e}^{- j 2 π l ( \frac{{kN}_{OFDM} ɛ}{N} )} + … + {e}^{- j 2 π ( {l}_{sum} - 1 ) ( \frac{{kN}_{OFDM} ɛ}{N} )} ) + {N}_{noise , l ∼ {l}_{sum} - 1} & ( 2 ) \\ \frac{{S}_{l + {l}_{sum} , k}}{{P}_{l + {l}_{sum} , k}} + \frac{{S}_{l + {l}_{sum} + 1 , k}}{{P}_{l + {l}_{sum} + 1 , k}} + … + \frac{{S}_{l + 2 * {l}_{sum} - 1 , k}}{{P}_{l + 2 * {l}_{sum} - 1 , k}} + ( {N}_{noise , l + {l}_{sum}} + {N}_{noise , l + {l}_{sum} + 1} + … + {N}_{noise , l + 2 * {l}_{sum} - 1} ) = {H}_{k} \times {e}^{- j 2 π ( l + {l}_{sum} ) ( \frac{{kN}_{OFDM} ɛ}{N} )} ( 1 + {e}^{- j 2 π l ( \frac{{kN}_{OFDM} ɛ}{N} )} + … + {e}^{- j 2 π ( {l}_{sum} - 1 ) ( \frac{{kN}_{OFDM} ɛ}{N} )} ) + {N}_{noise , l + {l}_{sum} ∼ l + 2 * {l}_{sum} - 1} & ( 3 )\end{matrix}$$

Since a specific number of the symbols is accumulated, the values of N_{noise,l˜l}_{ₛᵤₘ}₋₁ and N_{noise,l+l}_{ₛᵤₘ}_{˜l+2*l}_{ₛᵤₘ}₋₁ approach zero. Then the equation (2) and the equation (3) perform a conjugate multiplication that obtains the equation (4):

$$( \frac{{S}_{l , k}}{{P}_{l , k}} + \frac{{S}_{l + 1 , k}}{{P}_{l + 1 , k}} + … + \frac{{S}_{l + {l}_{sum} - 1 , k}}{{P}_{l + {l}_{sum} - 1 , k}} ) \times {( \frac{{S}_{l + {l}_{sum} , k}}{{P}_{l + {l}_{sum} , k}} + \frac{{S}_{l + {l}_{sum} + 1 , k}}{{P}_{l + {l}_{sum} + 1 , k}} + … + \frac{{S}_{l + 2 * {l}_{sum} - 1 , k}}{{P}_{l + 2 * {l}_{sum} - 1 , k}} )}^{*} = {\vert {H}_{k} \vert}^{2} \times {\vert ( 1 + {e}^{- j 2 π l ( \frac{{kN}_{OFDM} ɛ}{N} )} + … + {e}^{- j 2 π ( {l}_{sum} - 1 ) ( \frac{{kN}_{OFDM} ɛ}{N} )} ) \vert}^{2} \times {e}^{- j 2 π {l}_{sum} ( \frac{{kN}_{OFDM} ɛ}{N} )} \qquad ( 4 )$$

After that, a phase is retrieved shown as the equation (4), that is the exponent part thereof. Next, the phase is divided by lₛᵤₘ to obtain the phase difference between the adjacent symbols, such as the equation (5):

$$2 π {l}_{sum} ( \frac{{kN}_{OFDM} ɛ}{N} ) = \frac{arg \{ \begin{matrix}( \frac{{S}_{l , k}}{{P}_{l , k}} + \frac{{S}_{l + 1 , k}}{{P}_{l + 1 , k}} + … + \frac{{S}_{l + {l}_{sum} - 1 , k}}{{P}_{l + {l}_{sum} - 1 , k}} ) \times \\ {( \frac{{S}_{l + {l}_{sum} , k}}{{P}_{l + {l}_{sum} , k}} + \frac{{S}_{l + {l}_{sum} + 1 , k}}{{P}_{l + {l}_{sum} + 1 , k}} + … + \frac{{S}_{l + 2 * {l}_{sum} - 1 , k}}{{P}_{l + 2 * {l}_{sum} - 1 , k}} )}^{*}\end{matrix} \}}{{l}_{sum}} \qquad ( 5 )$$

After that, the phase difference is operated by means of the least error sum of squares operation, and a sampling frequency offset ε is obtained. Next, this offset value is transmitted to a sampling-frequency-offset weight accumulating circuit to obtain an accumulated sampling frequency offset εₛᵤₘ. Subsequently, this accumulated sampling frequency offset value performs a conjugate multiplication to the original signals in accordance with the positions of the carriers such as the value k in equation (1), and the signals to be compensated are shown as:

$${S}_{l , k} \times {e}^{j2π ( \frac{{kN}_{OFDM} {ɛ}_{sum}}{N} )} = {H}_{k} \times {P}_{l , k} + {N}_{noise , l} \qquad ( 6 )$$

The primary steps can be deduced from the above-mentioned process. The steps begin from a first step of receiving the signals. The signals are those influenced by the sampling frequency offset. Next, the pilot signals within are retrieved, and the input signals are calculated. Next, the original signals which are not influenced are employed to obtain the number of symbols through the equations (2) and (3). Further, the phase difference between the adjacent symbols is obtained by a conjugate operation, and then the phase difference is used to obtain the sampling frequency offset value by means of a least-error-sum-of-squares operation.

In order to compensate the sampling frequency offset, a block diagram of the circuit for estimating and compensating the sampling frequency offset is provided by the prior art, such as the diagram shown in FIG. 1.

The figure shows a sampling circuit 101 that is used to receive the selected pilot signals. The input signals are described as equation (1). More, a circuit 103 receives and stores those pilot signals into the memory medium in the form of complex number. Next, the stored signals are separated into two sets of symbols for further operation, and the results are described as the mentioned equation (2) and equation (3) respectively. The results of the operation are further received by the circuits 105 and 107 respectively, and the symbols are separately accumulated by the accumulating circuits 109 and 111.

A multiplier, which is implemented by the conjugate multiplication circuit 113, performs the conjugate multiplication between the two accumulated symbols. Its result is described as equation (4). Further, the circuit 115 is used to obtain the phases, and compute the phase difference between the adjacent symbols. The phase difference is described as equation (5). Next, the circuit 117 operates by means of least-error-sum-of-squares, so as to obtain the sampling frequency offset (SFO).

The sampling frequency offset is introduced into a sampling-frequency-offset weight accumulating circuit 119, so as to obtain an accumulated sampling frequency offset. Next, the circuit 121 multiplies the accumulated sampling frequency offset value by a carrier position, and a conjugate multiplication circuit 123 performs a conjugate multiplication on the original signal with the corresponding carrier position. Next, the signal to be compensated is obtained and shown as equation (6).

At last, an equalization circuit next to the sampling frequency offset compensation circuit uses a complex number division operator 125 to apply the compensated signals to an original pre-set channel, so as to eliminate the channel effect.

According to the equations (2), (3), (4) and (6), besides the circuit for storing the complex number of the signals and the conjugate multiplication circuit are required to estimate the sampling frequency offset, an additional conjugate multiplication circuit is also required to compensate the offset in a conventional circuit. Therefore the cost of hardware will increase.

In addition, the complex number division operator adopted by the mentioned equalization circuit is very complicated, such as the regular way having a complex number multiplier, a division operator, two multipliers, one adder and a radical operation.

Since the conventional sampling frequency offset estimation circuit is to use the circuit for storing the signal with complex number to store the signals, and further to subtract the phase in the conjugate multiplication circuit. The hardware costs. More, in order to avoid the influence caused by the channel effect, the channel estimation cannot work before the equalizer but after the equalizer as the sampling frequency offset estimation circuit operates. So that, the estimation is limited by the equalizer and having very low convenience and integration.

### SUMMARY OF THE DISCLOSURE

Other than the sampling frequency offset estimation circuit of the prior art that utilizes the circuit for storing the complex number of the signal to store the signals, and the circuit for conjugate multiplication to operate the phase subtraction, the present invention provides an apparatus and the method of the sampling frequency offset estimation. Particularly, a concept of linear function is introduced to the invention, and that is only to utilize the circuit for storing the phases of the signals to store the phases, but not the circuit for storing the complex numbers of the signals. Thereby, the present invention accomplishes the sampling frequency offset estimation, reducing the storing circuits by incorporating the compensation circuit, and operating the circuit of conjugate multiplication, and, consequently to compensate the sampling frequency offset.

In order to replace the huge hardware required by the prior art, such as the circuit for storing the complex numbers of the signals and the circuit of conjugate multiplication, the present invention provides a preferred embodiment of the estimating method. Firstly, a sampling frequency offset estimation circuit is used to receive the signals that are retrieved to calculate the phase of each signal. Next, the pilot signals are retrieved. Next, the subtraction is processed to obtain the phase differences between the retrieved pilot signals and the pilot signals that delay for a plurality of symbols. A circuit for storing the signal phase difference is used to store the phase differences after the number of accumulated symbols reaches a specific number. A circuit for accumulating and calculating the phases between the adjacent symbols is further used to accumulate the phases of the symbols, so as to eliminate the systematic noise and the intercarrier interference.

According to the sampling frequency offset estimation circuit of the present invention, a least-error-sum-of-squares operation is used to calculate the phase difference between the adjacent symbols, so as to obtain an estimation value of the communication system.

After that, the estimation value will be introduced into the sampling frequency offset compensation circuit, and only a subtraction operation is performed between the weighted offset and the original signal phases in response to the carrier positions to obtain the signals to be compensated.

In which, the compensation circuit utilizes the mentioned estimation value to perform the steps of sampling frequency offset compensation. Next, the estimation value is introduced, and thereby to assign different weighting on different sampling frequency offset by means of an offset weight accumulating circuit, so as to obtain an accumulated offset. Further, the signals to be compensated are obtained by performing a subtraction operation between the accumulated offset and the original signals in response to the carrier positions.

### BRIEF DESCRIPTION OF DRAWINGS

The present invention will be readily understood by the following detailed description in conjunction accompanying drawings, in which:

FIG. 1 shows a design of an equalizer disposed between a sampling frequency offset estimation circuit and a sampling frequency offset compensation circuit;

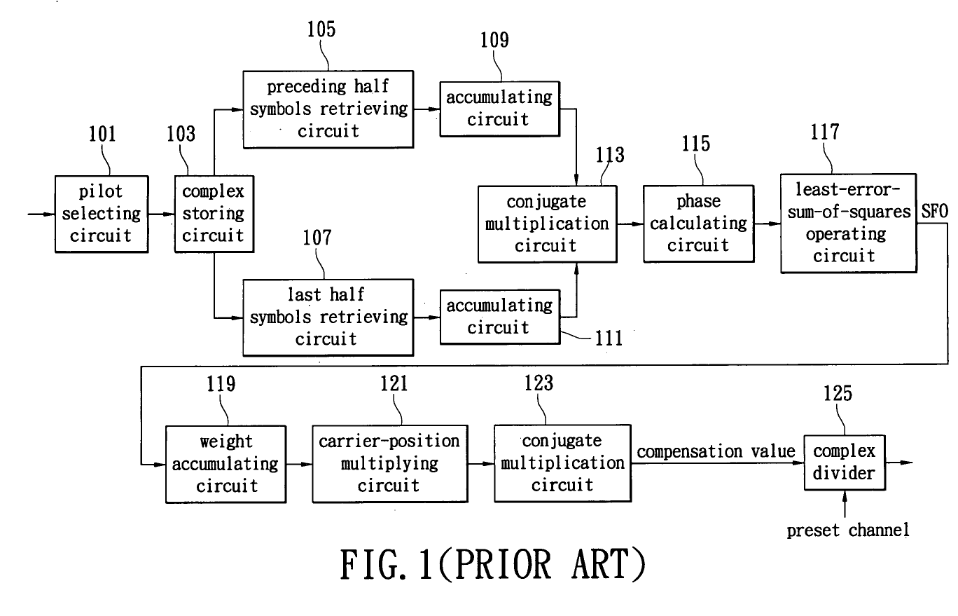

FIG. 2 shows a schematic diagram of the sampling frequency offset estimation apparatus of the present invention;

FIG. 3 shows a circuitry block diagram of the sampling frequency offset compensation circuit of the present invention;

FIG. 4 shows a circuitry block diagram of the sampling frequency offset estimation and compensation apparatus of the present invention;

FIG. 5 shows a flow chart of the method of sampling frequency offset estimation of the present invention;

FIG. 6 shows a flow chart of the method of sampling frequency offset compensation of the present invention.

### DETAILED DESCRIPTION OF THE PREFERRED EMBODIMENTS

To understand the technology, means and functions adopted in the present invention further, reference is made to the following detailed description and attached drawings. The invention shall be readily understood deeply and concretely from the purpose, characteristics and specification. Nevertheless, the present invention is not limited to the attached drawings and embodiments in following description.

In a communication system, the problem of the circuit itself, such as the analog-to-digital conversion, causes the sampling frequency offset. Especially in the OFDM system, the offset happens during every conversion, and the offset will be magnified as time flies. Further, the following modulation would be error. Other than the way to obtain the phase difference by the correlation of the adjacent signals and the conjugate multiplication of the prior art, the compensating apparatus and method for the sampling frequency estimation of the present invention is to obtain the phase angle for each signal (or symbol) at first step, and obtain the phase difference by direct subtraction, and obtain the average value over the phase differences during the process of the sampling frequency offset estimation. After that, the part of noisy interference can be eliminated.

In order to reduce the hardware consumption, the invention features that the provided sampling frequency offset estimation circuit can still be used to estimate the sampling frequency offset of the communication system, and the compensation circuit can be used to compensate the signals influenced by the sampling frequency offset. One of the objects of the invention is to design the hardware having less consumption, in which the apparatus includes the sampling frequency offset estimation circuit, the circuit for storing the signal phases, and the circuit for calculating the phase differences. So that the claimed apparatus substitutes for the prior art that costs large hardware consumption to store the signals with real part and complex part and the circuit operating conjugate multiplication.

In order to implement the provided circuits of the present invention, a linear concept in mathematics is mainly employed to reduce the hardware cost, as follows.

The apparatus for estimating and compensating sampling frequency offset of the present invention starts to receive the signals influenced by the sampling frequency offset in the beginning, the received signals can be described as equation (1):

$${S}_{l , k} = {H}_{k} \times {P}_{l , k} \times {e}^{- j 2 π l ( \frac{{kN}_{OFDM} ɛ}{N} )} + {N}_{noise , l} \qquad ( 1 )$$

In which, Hₖ presents the channel effect, and P_{l,k} presents the original signals without any influence, and ε is the sampling frequency offset value. One of the objects of the present invention is to minimize the noise and intercarrier interference, involved in N_{noise,l}, caused by the sampling frequency offset. Next, the carriers with pilot signals of the input signals influenced by the sampling frequency offset are divided by P_{l,k} and the phases thereof are extracted and described as equation (7). Only the phase for each signal should be stored in the present invention.

$$arg \{ \frac{{S}_{l , k}}{{P}_{l , k}} \} = arg \{ {H}_{k} \} - j 2 π l ( \frac{{kN}_{OFDM} ɛ}{N} ) + arg \{ {N}_{noise , l} \} \qquad ( 7 )$$

Next, the phases of a symbol and another one with an interval of lₛᵤₘ symbols are subtracted, that is, the phases of the symbol with lₛᵤₘ symbols delay and the original received signals are subtracted, as described in equation (8). In which, the subscript shown in the equation (8) presents the interval of lₛᵤₘ.

$$arg \{ {Y}_{l , k} \} = arg \{ \frac{{S}_{l , k}}{{P}_{l , k}} \} - arg \{ \frac{{S}_{l + {l}_{sum} , k}}{{P}_{l + {l}_{sum} , k}} \} = 2 π {l}_{sum} ( \frac{{kN}_{OFDM} ɛ}{N} ) + ( arg \{ {N}_{noise , l} \} - arg \{ {N}_{noise , l + {l}_{sum}} \} ) \qquad ( 8 )$$

Since the phase after subtraction described in equation (8) has a probability being larger than π or smaller than −π, the later operation will get a serious error. Therefore, the phase difference after subtraction needs to be adjusted in a range of ±π, which is shown as equation (9):

$$arg \{ {Y}_{l , k} \} = \{ \begin{matrix}arg \{ {Y}_{l , k} \} - π & if arg \{ {Y}_{l . k} \} > π \\ arg \{ {Y}_{l , k} \} + π & if arg \{ {Y}_{l , k} \} < - π\end{matrix} \qquad ( 9 )$$

Since the (arg{N_{noise,l}}−arg{N_{noise,l+l}_{ₛᵤₘ}}) in equation (8) includes the phases with noises and the intercarrier interferences, the interferences can be minimized by accumulating a specific number of symbol phases. The accumulated symbols for a successive period of time can be described as equation (10):

$$arg \{ {Y}_{l , k} \} + arg \{ {Y}_{l + 1 , k} \} + … + arg \{ {Y}_{l + {l}_{sum} - 1 , k} \} = {l}_{sum} \times [ 2 π {l}_{sum} ( \frac{{kN}_{OFDM} ɛ}{N} ) ] + arg \{ {N}_{noise , l \sim l + 2 * {l}_{sum} - 1} \} \qquad ( 10 )$$

Since a number of symbols are accumulated, the value of arg{N_{noise,l˜l+2*l}_{ₛᵤₘ}₋₁} approaches zero. Further, the phase difference between the adjacent symbols can be obtained after the equation (10) is divided by lₛᵤₘ². The phase difference is described as equation (11) which uses a least-error-sum-of-squares operation to obtain the estimation value of sampling frequency offset.

$$2 π ( \frac{{kN}_{OFDM} ɛ}{N} ) = \frac{arg \{ {Y}_{l , k} \} + arg \{ {Y}_{l + 1 , k} \} + … + arg \{ {Y}_{l + {l}_{sum} - 1 , k} \}}{{l}_{sum}^{2}} \qquad ( 11 )$$

After that, the phases of signals are retrieved. The signals that are compensated can be obtained from a subtraction operated between the value εₛᵤₘ and the phases of the original signals according to the positions of the carriers such as the value k in equation (1). The signals to be compensated can be described as equation (12):

$$arg \{ {S}_{l , k} \} - [ - j2π ( \frac{{kN}_{OFDM} {ɛ}_{sum}}{N} ) ] = arg \{ {P}_{l , k} \times {H}_{k} \} + arg \{ {N}_{noise , l} \} \qquad ( 12 )$$

In mathematics, in view of the equations (8), (10) and (12), only a circuit for storing signal phase is used to store the phases as estimating the sampling frequency offset in the present invention. So that, the circuit for storing the complex number with real part and imaginary part is not requisite. The phase-difference calculating circuit of the present invention is used to achieve the subtraction between the phases, but not the conjugate multiplication circuit. Further, the phase-difference calculating circuit in substitution for the conjugate multiplication circuit can apparently reduce the cost.

Furthermore, an equalization circuit next to the mentioned sampling frequency offset compensation circuit can either be implemented by a complex divider, the more complicated scheme, or by the less complicated scheme such as phase subtraction and amplitude subtraction. Since the signal from the sampling frequency offset compensation circuit is in form of phase, the following circuits can reduce the hardware cost by the mentioned scheme.

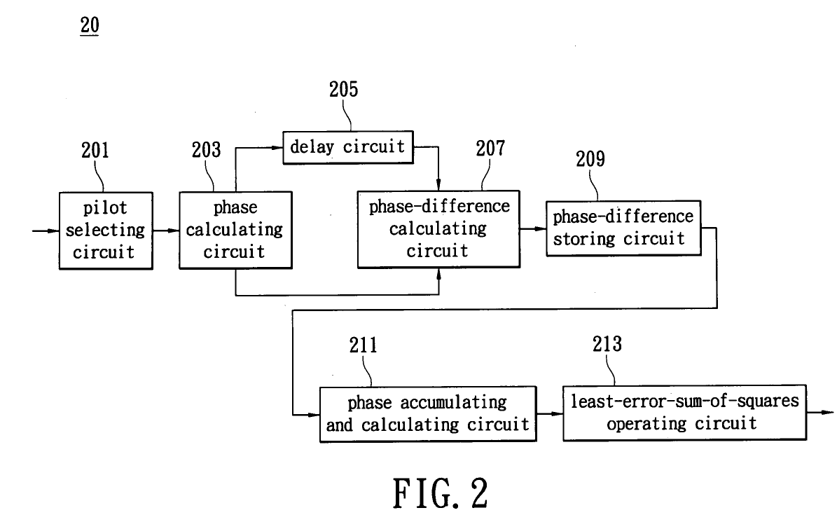

FIG. 2 shows the circuitry block diagram of the sampling frequency offset estimation apparatus of the present invention. More particularly, the circuit for storing signal phase or the buffer memory is incorporated, rather than the circuit for storing complex number of the signals. Additionally, the phase difference is obtained by only performing phase subtraction, but not the conjugate multiplication circuit.

As the signals enter the system, the sampling frequency offset estimation circuit 20 shown in FIG. 2 receives. The phase calculating circuit 201 is used to calculate the phase value for each symbol, as described in equation (7). Next, a pilot symbol selecting circuit 203 retrieves the pilot symbols of the symbols, such as the signal described in equation (1). After that, the sampling frequency offset of the whole system can be obtained by calculating the phase difference of the pilot symbols.

In the meantime, the phase difference values are obtained by the subtraction operation between the received signals and the pilot signals delayed for a plurality of symbols by the delay circuit 205. Next, the phase-difference calculating circuit 207 is described as equation (8) that is used to perform the subtraction of the symbols. The mentioned phase-difference calculating circuit substitutes the scheme of accumulating the number of symbols and the conjugate multiplication for obtaining the phase differences.

Rather than the circuit for storing every signal of the prior art, only the circuit for storing phase difference 209 is used to store the phase differences obtained by the phase-difference calculating circuit 207. The equation (9) adjusts the values after subtraction within ±π before storing the phase differences. Next, a circuit 211 for accumulating and calculating the phases of the adjacent symbols to a specific number of symbols. The equation (10) describes the equation for minimizing the noise and the intercarrier interference in the system.

A circuit 211 for accumulating and calculating the phases between the adjacent symbols implements the equation (11). Then the accumulated symbol phases are delivered to the least-error-sum-of-squares operating circuit 213, thereby to obtain the phase differences between the adjacent symbols. The phase differences are the sampling frequency offset values of the communication system after the least-error-sum-of-squares operation.

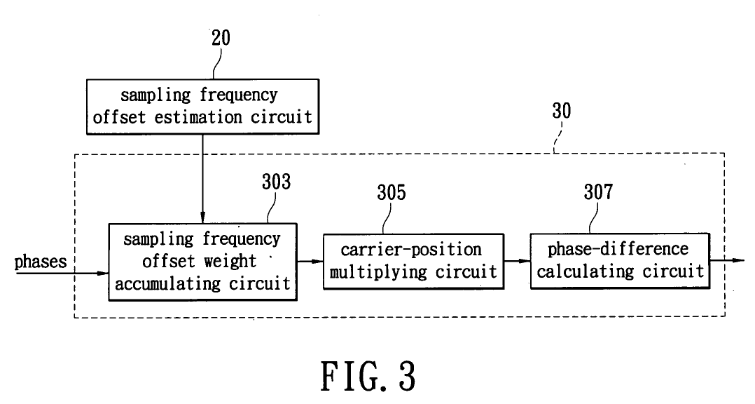

According to the present invention, such as equation (12) describes, the compensated signals will be obtained as performing the subtraction operation between the original signals and the signals in different carrier positions. Reference is made to FIG. 3 showing the block diagram of the embodiment of compensation circuit.

Referring to FIG. 2, the estimation value obtained from the sampling frequency offset estimation circuit 20 is introduced into the sampling frequency offset compensation circuit 30 shown in FIG. 3. After that, the signals to be compensated are obtained by performing the subtraction operation between the phases of original signals and the accumulated offsets εₛᵤₘ in response to the different carrier positions.

The compensation circuit receives the phase calculated by the sampling frequency offset estimation circuit 20. Next, the offset estimation value ε of the communication system is introduced into a sampling frequency offset weight accumulating circuit 303, so as to assign each symbol the different weight on the sampling frequency offset. All the offset values are added to obtain the sampling frequency offset εₛᵤₘ after accumulation.

Next, a carrier-position multiplying circuit 305 is used to multiply each symbol and the signals with carrier positions, that is, each sample of each symbol corresponds to each position of each carrier. Next, a phase-difference calculating circuit 307 performs the subtraction operation between the original signals and the εₛᵤₘ with corresponding carrier-position, so that the compensated signal is obtained.

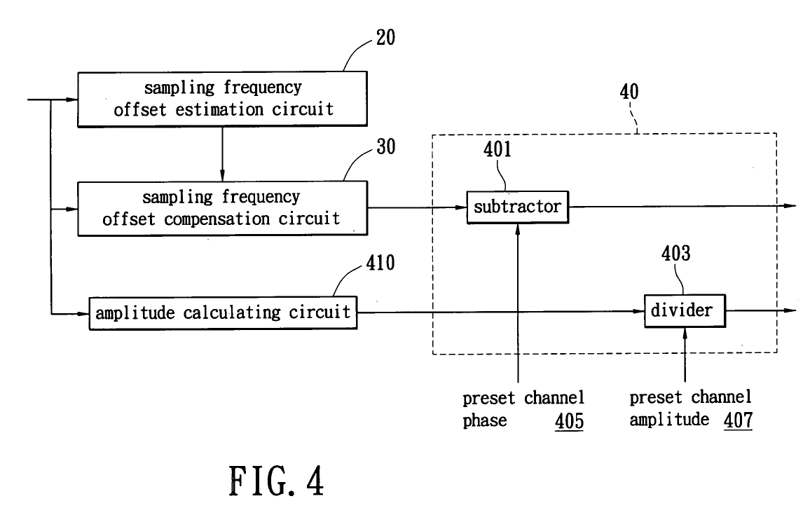

The invention has another advantage of avoiding the equalizer limiting the estimation quality since the equalizer of the present invention is disposed after the claimed sampling frequency offset estimation circuit 20 and the sampling frequency offset compensation circuit 30. Reference is made to FIG. 4, which shows the offset estimation value is obtained from the sampling frequency offset estimation circuit 20, and introduced into the sampling frequency offset compensation circuit 30 to obtain the compensated signals. Further, the equalization circuit 40 shown in FIG. 4 is provided to eliminate the channel effect.

In this equalization circuit 40, other than the conventional complex divider with complicated operation, a subtractor 401 shown in FIG. 4 is provided to perform a subtraction operation between the signals of the preset channel phases (405) and the compensated signals before entering this system. Thus the channel effect can be eliminated. More, the equalization circuit 40 can receive the signal amplitude

Since the divider 403 has complicated hardware design, the cooperation of the sampling frequency offset estimation circuit and sampling frequency offset compensation circuit can ignore the complex divider. Therefore, the following circuitry cost can be reduced further.

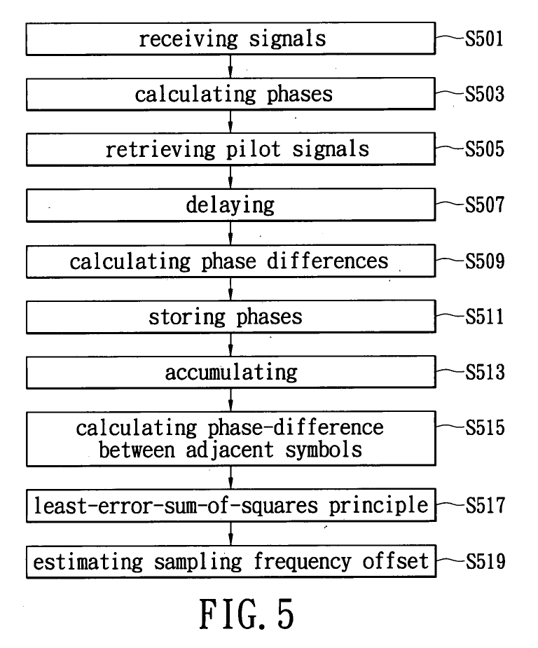

To sum up the above-mentioned estimation calculation and reference is made to the flow chart shown in FIG. 5. The flow chart shows the steps of sampling frequency offset estimation of the present invention. Referring to the estimation circuit shown in FIG. 2, a step of receiving signals in S501 is provided in the beginning of the steps. After that, the signals influenced by the sampling frequency offset are obtained. Next, the method goes to calculate the phases of the signals (step S503), and to retrieve the pilot signals therein (step S505). Next, a delay circuit is used to delay a plurality of symbols in step S507. A subtraction operation is performed on the phases of the signals with delayed symbols and the original received pilot signals (step S509). In this, the phase difference should be ranged within ±π.

Since the phase differences are obtained, only the circuit for storing the phase differences or the relevant buffer memory are employed (step S511). Further, the method goes to accumulate the symbols in step S513. Next, the phase differences between the adjacent symbols are obtained (step S515). After that, a least-error-sum-of-squares operation is used to obtain the sampling frequency offset estimation values (steps S517, S519).

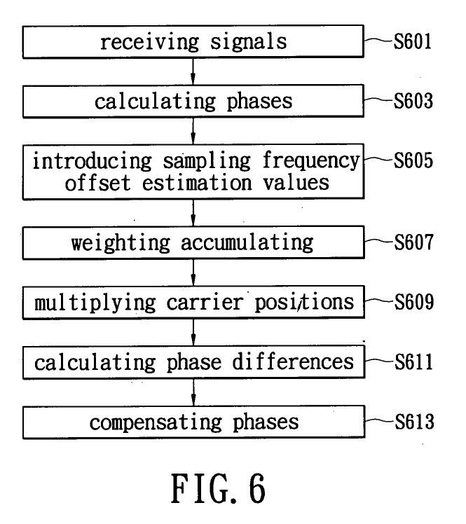

FIG. 6 shows a flow chart of the sampling frequency offset compensation using the estimation values. The communication system receives the signals firstly, especially to the symbols influenced by the sampling frequency offset (step S601). The phases of the pilot signals are calculated since the phases are obtained by the sampling frequency offset estimation circuit of the communication system (step S603). In the meantime, the estimation values obtained from the sampling frequency offset estimation circuit are introduced into a sampling frequency offset compensation circuit (step S605). Since the estimation values of the system are introduced, a offset weight accumulating circuit is used to assign different weighting on the sampling frequency offsets, and further to accumulate the sampling frequency offsets with different weighting in step S607. To accumulate the phases of the symbols in a specific period can eliminate the interference.

After obtaining the accumulated offsets, the corresponding carrier position for each symbol can be obtained as the symbol multiplying the carrier position (step S609). A subtraction operation is performed between the original symbols and the accumulated offset according to the different carrier positions (step S611). The signals to be compensated are obtained (step S613).

The sampling frequency offset estimation circuit and compensation circuit of the present invention have the following merits in comparison with the prior art:

1. The sampling frequency offset estimation circuit can be a circuit for storing phases in substitution for the circuit for storing complex number of the conventional design. The buffer memory in the communication system can only store the phases, but not to store the real part and the imaginary part of the complex number. The buffer memory can be saved.

2. The sampling frequency offset estimation circuit of the present invention can be implemented as a circuit for calculating phase difference in substation for the conjugate multiplication circuit for saving the consumption of a multiplier.

3. The sampling frequency offset compensation circuit can be implemented as circuit for calculating phase difference in substitution for the conjugate multiplication circuit. A multiplier can be saved.

4. The equalization circuit of the present invention can be implemented as a circuit for calculating phase difference and an amplitude divider in substitution for a complex divider. The complex divider can be saved.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. An apparatus for estimating sampling frequency offset, comprising:
a) a phase calculating circuit for calculating a phase value of the symbols influenced by the sampling frequency offset;
b) a pilot symbol selecting circuit for retrieving the pilot symbols in the symbols;
c) a delay circuit for delaying the received symbol for a plurality of symbols;
d) a phase-difference calculating circuit for obtaining one or more phase differences by a subtraction operation processed on the received symbols and the delayed pilot symbols;
e) a phase-difference storing circuit for storing the phase differences;
f) an accumulating circuit for accumulating the phases between the adjacent symbols in a successive period; and
g) a least-error-sum-of-squares operating circuit for obtaining an estimation value for a sampling frequency offset by a least-error-sum-of-squares operation.

2. The estimation apparatus of claim 1, wherein the phase-difference calculating circuit is used to adjust the phase difference within ±π before the phase-difference storing circuit stores the phase differences.

3. The estimation apparatus of claim 1, wherein the phase difference storing circuit is implemented as a buffer memory.

4. A sampling frequency offset compensation apparatus for the estimation value obtained by the estimation apparatus of claim 1, comprising:
a) a phase calculating circuit for calculating the phase of the received signals;
b) a sampling-frequency-offset weight accumulating circuit, which introduces the sampling frequency offset estimation value and offers the estimation value for each symbol different weight, and then obtains an accumulated sampling-frequency-offset value;
c) a carrier-position multiplying circuit for multiplying each symbol by the carrier position and obtaining a corresponding carrier position; and
d) a phase-difference calculating circuit for subtracting the carrier position from the original signal phase and obtaining the compensated signal.

5. The compensation apparatus of claim 4, wherein the compensation apparatus eliminates the channel effect through an equalization circuit.

6. The compensation apparatus of claim 5, wherein the equalization circuit further comprises a subtractor for subtracting a pre-estimated channel phase from the compensated signal.

7. The compensation apparatus of claim 5, wherein the equalization circuit receives a signal from an amplitude calculating circuit and operates a division operation with a pre-estimated channel amplitude.

8. A method for estimating a sampling frequency offset, comprising:
a) receiving the symbols influenced by sampling frequency offset;
b) calculating a phase for each symbol;
c) retrieving pilot symbols;
d) delaying a plurality of symbols;
e) obtaining a phase difference by means of subtracting the received pilot symbols from the delayed symbols;
f) storing the phase differences;
g) accumulating the phases of the symbols;
h) calculating the phase difference between the adjacent symbols; and
i) obtaining an estimation value of the sampling frequency offset of a communication system.

9. The estimation method of claim 8, wherein a delay circuit is used to delay the plurality of symbols.

10. The estimation method of claim 8, wherein the phase differences after subtracting are adjusted within ±π.

11. The estimation method of claim 8, wherein a storing circuit is used to store the phase differences.

12. The estimation method of claim 8, wherein a least-error-sum-of-squares operation is used to obtain the estimation value of sampling frequency offset.

13. The estimation method of claim 8, wherein a phase-difference calculating circuit performs the phase subtraction.

14. A sampling frequency offset compensation method for the estimation value introduced from claim 8, comprising:
a) receiving the symbols influenced by sampling frequency offset;
b) introducing the estimation value of sampling frequency offset;
c) accumulating the sampling frequency offset values processed with different weights;
d) multiplying each sample of each symbol by each carrier position for obtaining the corresponding carrier positions for each symbol;
e) subtracting the different carrier positions from accumulated sampling frequency offset values in accordance with the original received symbols; and
f) obtaining the compensated symbols.

15. The compensation method of claim 14, wherein a phase-difference calculating circuit is used to perform a subtraction operation between the accumulated sampling frequency offset values and the phase of original received symbols.

16. The compensation method of claim 14, wherein an equalization circuit is used to eliminate the channel effect by using the compensated symbols.

17. The compensation method of claim 16, wherein a subtraction operation between the compensated symbols and a pre-estimated channel phase is used to eliminate the channel effect.

18. The compensation method of claim 17, wherein a subtractor performs the subtraction.

19. The compensation method of claim 16, wherein the equalization circuit further receives the signals from an amplitude calculating circuit, and operates a division operation with a pre-estimated channel amplitude.
